(19) United States
(12) Patent Application Publication
(10) Pub. No.: US 2005/0055409 A1
(43) Pub. Date: Mar. 10, 2005

(54) Targeted email promotion

(75) Inventors: Laith Alsarraf, Encino, CA (US); Pablo Franzetti, Potomac, MD (US)

Correspondence Address: MCDERMOTT, WILL & EMERY, 2049 Century Park East, Suite 3400, Los Angeles, CA, 90067, US

(73) Assignee: Spectaris, LLC

(21) Appl. No.: 10/821,654

(22) Filed: Apr. 9, 2004

Related U.S. Application Data
(60) Provisional application No. 60/500,981, filed on Sep. 8, 2003.
(60) Provisional application No. 60/549,638, filed on Mar. 3, 2004.

(51) Int. Cl. G06F 15/16

(52) U.S. Cl. 709/206

(57) ABSTRACT

An email-based promotional message delivery system. The system may append targeted promotional messages to outgoing emails. The system may use the profiles of senders as a means of targeting the recipients. The system may use a recipient profile supplied by one sender as a means of targeting the same recipient when that recipient is sent a message by a different sender. A two-tier spam blocking system may be offered as an inducement to allowing promotional messages to be added to outgoing emails. Other features and processes are disclosed.

### CROSS-REFERENCE TO RELATED APPLICATIONS

This application is related to and claims priority to U.S. Provisional Application Ser. No. 60/500,981, filed Sep. 8, 2003, entitled “Targeted Email Promotion and Two-Tier Filtering,” and U.S. Provisional Application Ser. No. 60/549,638, filed Mar. 3, 2004, entitled “Targeted Email Promotion and Two-Tier Filtering System and Method,” attorney docket no. 68983-012. Both of these provisional applications are incorporated herein by reference.

### BACKGROUND

1. Field

This application relates to email promotional messages and to email filtering.

2. Background

Businesses are always in search of effective and cost efficient advertising. To this end, spam has been used by several companies.

Spam, however, is a growing problem for consumers and companies. Spam can cause a variety of problems, including lost time and productivity, increased exposure to security breaches, and the delivery of unwanted and sometimes harmful content. Efforts to delete unwanted spam sometimes result in the deletion of desired emails. The growth of spam and its associated problems are approaching levels that threaten the utility of the email communication system.

Increased dislike of spam and the problems it may cause, decreased attention given to the contents of spam, and growing legislation against spam are all causing the attractiveness and effectiveness of this form of advertising to diminish.

### SUMMARY

An email-based promotional message delivery system may include a sender profile database configured to store a profile of each of a plurality of potential email senders; a promotional message database configured to store a plurality of promotional messages and, for each, a profile of preferred recipients of the message; and a processing system. The processing system may be configured to receive a plurality of outgoing emails from a plurality of different senders, each email containing information identifying the sender and at least one recipient. The processing system may be configured in connection with each received email to locate the profile of the sender in the sender profile database; locate at least one promotional message in the promotional message database that has a profile that is appropriate for the profile of the sender; add the at least one located promotional message to the email; and direct the augmented email to the at least one recipient of the email.

An email address database may be configured to be accessed electronically by an email application and configured to store and deliver information identifying a plurality of potential email recipients and, in connection with each, information about his or her income, vocation, race, number of children and/or hobbies.

An email-based promotional message delivery system may include a recipient profile database configured to store a profile of each of a plurality of potential email recipients; a promotional message database configured to store a plurality of promotional messages and, for each, a profile of preferred recipients of the message; and a processing system. The processing system may be configured to receive recipient profiles from email address databases maintained by a plurality of email senders and store the recipient profiles in the recipient profile database. The processing system may be configured to receive an outgoing email from an email sender, the email containing information identifying at least one intended recipient of the email; locate the profile of the intended recipient in the recipient profile database; locate at least one promotional message in the promotional message database that has a profile that is appropriate for the located profile of the at least one intended recipient; add the at least one located promotional message to the email; and direct the augmented email to the at least one intended recipient.

An email-based system may include a recipient database configured to store information identifying recipients that have clicked links embedded in their email messages and information identifying the links that the recipients have clicked, as well as a processing system. The processing system may be configured to receive reports about recipients that have clicked links embedded in their email messages and update the recipient database to reflect information in the reports.

An email-based system may include a recipient database configured to store information identifying recipients that have clicked links embedded in their email messages and a profile of each recipient, as well as a processing system. The processing system may be configured to receive reports about recipients that have clicked links embedded in their email messages and update the recipient profiles in the recipient database based on the reports.

An email-based modification system may include a sender database configured to store information about a plurality of email senders, including information about the number of emails from each sender that the modification system has modified, and a processing system. The processing system may be configured to receive a plurality of emails from the plurality of senders, each email containing information identifying the sender and at least one recipient. The processing system may be configured in connection with each received email to modify the email; direct the modified email to the at least one recipient; and update the information in the sender database about the number of emails from the sender to reflect that another email has been modified.

A spam blocking system may include an approved sender database configured to store information identifying a plurality of senders that have been approved to send emails to a recipient, as well as a processing system. The processing system may be configured to receive an incoming email from a sender to the recipient; determine whether information identifying the sender is in the approved sender database; if information identifying the sender is not in the approved sender database, direct the sender to take a test configured to only be passable with input from an individual; determine whether the sender has passed the test; and if the sender has passed the test, place information identifying the sender in the approved sender database.

The test may be to enter characters appearing against a partially-obscuring background on a webpage.

The processing system may be configured to ask the recipient whether to place information identifying the sender in the approved sender database before placing the information identifying the sender in the approved sender database.

The processing system may be configured to deliver the email to the recipient if the sender passes the test.

The processing system may be configured to redirect or block the email from reaching the recipient if the sender does not pass the test.

The processing system may be configured to deliver the email to the recipient if information identifying the sender is in the approved sender database.

The spam blocking system may include a blocked sender database configured to store information identifying a plurality of senders that are to be blocked from sending emails to the recipient. The processing system may be configured to determine whether information identifying the sender is in the blocked sender database; and if information identifying the sender is in the blocked sender database, not to direct the sender to take the test and to redirect or block the email from reaching the recipient.

Processes may be performed to implement one or more of the functions discussed above. Computer-readable storage media may contain computer-readable instructions which cause a computing system to implement one or more of these processes when installed in the computing system.

These, as well as other objects, features and benefits will now become clear from review of the following detailed description of illustrative embodiments and the accompanying drawings.

### BRIEF DESCRIPTION OF DRAWINGS

FIG. 1 illustrates one embodiment of a targeted email promotion system with two-tier filtering.

FIG. 2 illustrates one embodiment of a record in the email address database illustrated in FIG. 1.

FIG. 3 illustrates one embodiment of the sender profile database illustrated in FIG. 1.

FIG. 4 illustrates one embodiment of the recipient profile database illustrated in FIG. 1.

FIG. 5 illustrates one embodiment of the promotional message database illustrated in FIG. 1.

FIG. 6 illustrates one embodiment of the sender database illustrated in FIG. 1.

FIG. 7 illustrates one embodiment of the recipient database illustrated in FIG. 1.

FIG. 8 illustrates one embodiment of a targeted email promotion process.

FIG. 9 illustrates another embodiment of a targeted email promotion process.

FIG. 10 illustrates one embodiment of a promotional accounting process.

FIG. 11 illustrates one embodiment of an automated recipient profile development process.

FIG. 12 illustrates one embodiment of a two-tier email filtering process.

FIG. 13 illustrates one embodiment of the web page test presented by the test website illustrated in FIG. 1.

### DETAILED DESCRIPTION OF ILLUSTRATIVE EMBODIMENTS

Illustrative embodiments of structure will be described first, followed by illustrative embodiments of processes that these or other structures may perform. The description of these structures and processes are for illustrative purposes only. Other structures and processes may be created and performed that include different combinations of components or steps, including combinations with more, less and/or different components or steps.

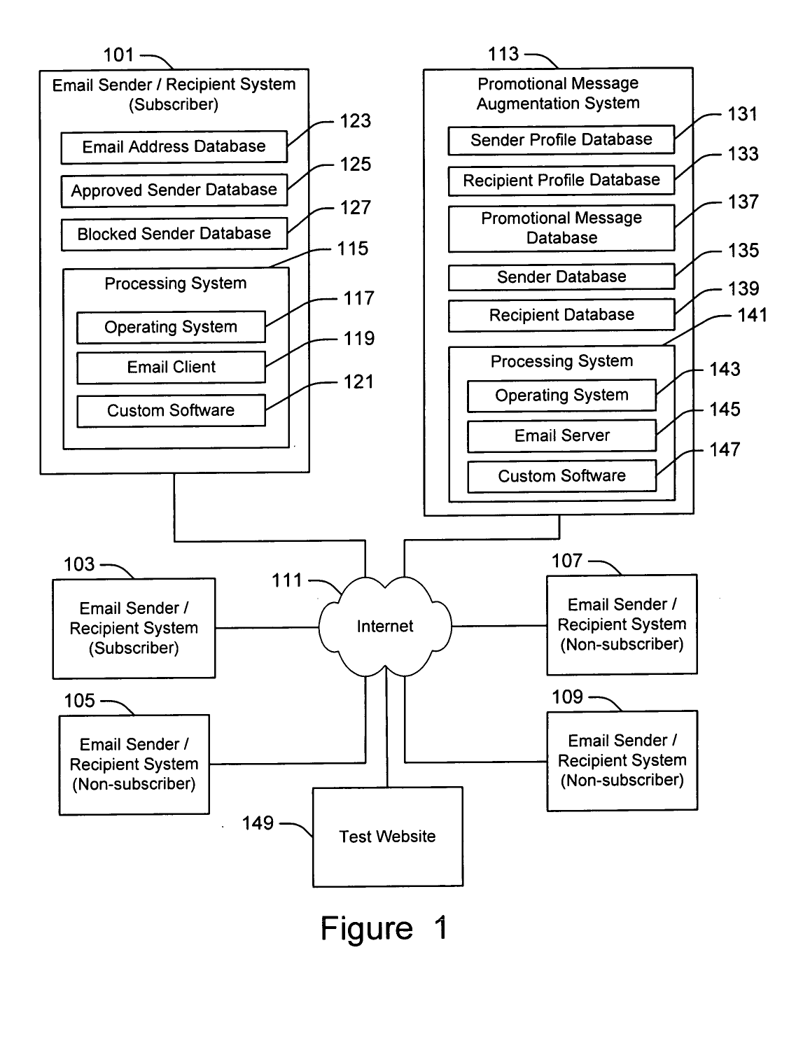

FIG. 1 illustrates one embodiment of a targeted email system with two-tier filtering.

As shown in FIG. 1, a plurality of email senders/recipient systems, such as email senders/recipient systems 101, 103, 105, 107 and 109, may be connected to a networked communication system, such as the Internet 111, along with a promotional message augmentation system 113. Some of the email senders/recipient systems may be subscribers to a product or service provided by the promotional message augmentation system 113, such as the email senders/recipient systems 101 and 103; while other email senders/recipient systems may not be subscribers, such as the email senders/recipient systems 105, 107 and 109.

Email sender/recipient system 101 may consist of a single computer or multiple computers configured to send and/or receive email. It may include a processing system 115, which may include an operating system 117 and an email client 119. The operating system 117 may be Windows, Unix, Linux, Netware or any other type of operating system. The email client 119 may be Outlook, Outlook Express, Eudora or any other type of email client. The various components of the email sender/recipient system 101 may or may not be at the same location.

Email senders/recipient systems that are subscribers, such as email senders/recipient system 101, may additionally include custom software, such as custom software 121. The custom software 121 may configure the email client 119 in various ways, including to designate email server 145 as the server which should handle incoming and/or outgoing email. The custom software may be configured to cooperate with the other components of the processing system 115 to perform one or more of the operations described herein. The custom software 121 may be written in accordance with well known programming techniques.

Email sender/recipient systems that are subscribers, such as email sender/recipient system 101, may include additional components, such as an email address database 123, an approved sender database 125 and/or a blocked sender database 127.

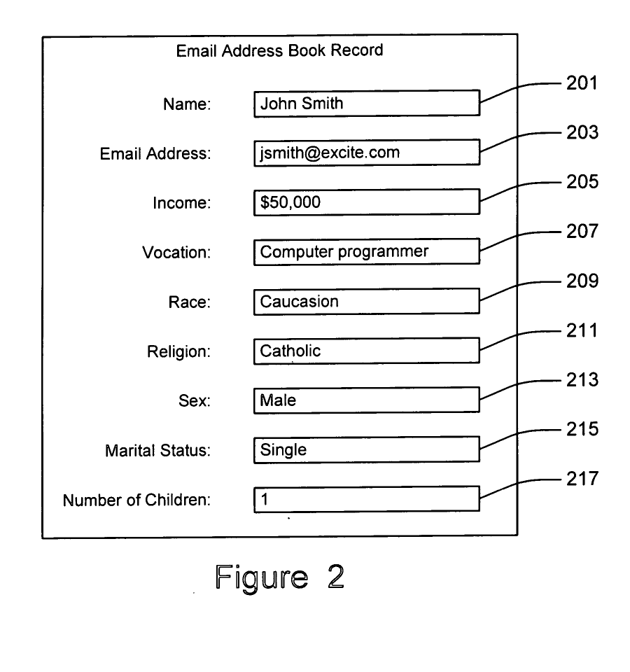

FIG. 2 illustrates one embodiment of a record in the email address database 123 illustrated in FIG. 1. As shown in FIG. 2, each record may include the name 201 of a recipient to whom the email sender/recipient system may send an email, his or her email address 203, and one or more fields of information that profile the recipient. The profile fields may include demographic information about the recipient, such as income 205, vocation 207, race 209, religion 211, sex 213, marital status 215 and/or number of children 217. Additional, a lesser number, and/or other profile fields may be used instead.

The approved sender database 125 may contain information identifying persons whom have been authorized to deliver emails to the sender/recipient system 101. Information in the approved sender database 125 may be entered by the user. The information may be imported from one or more contact databases. This may be done automatically upon creation of the database with the aid of the custom software 121.

The blocked sender database 127 may include information identifying persons whom have been blocked from delivering emails to the email sender/recipient system 101. The processing system 115 may be configured to completely block emails from senders listed in the blocked sender database 127 or merely to redirect them to a folder or other area that is segregated from other emails.

The other Email sender/recipient systems may be configured in the same or in different ways. Email sender/recipient systems that are not subscribes may be configured to point to email servers other than email server 145 to process their incoming and/or outgoing emails.

Although the Internet 111 is illustrated in FIG. 1 as being part of the backbone of the network communication system between the email senders/recipient systems 101, 103, 105, 107 and 109 and the promotional message augmentation system 113, other types of networked communications systems may be used in addition or instead, including LANs, WANs, wired systems and wireless systems. In this regard, the entire targeted email promotion system with two-tier filtering that is illustrated in FIG. 1 may be housed within a single organization and used exclusively by its members to deliver promotional messages and/or to block spam, all as will be explained in more detail below.

The promotional message augmentation system 113 may include a sender profile database 131, a recipient profile database 133, a sender database 137, a promotional message database 135, a recipient database 139 and a processing system 141. The processing system 141 may include an operating system 143, an email server 145 and custom software 147.

The operating system 143 may be any type of operating system, such as Windows, Unix, Linux or Netware. The email server 145 may be configured to send and/or receive email on behalf of subscribers to the promotional message augmentation system 113, such as on behalf of the email senders/recipient systems 101 and 103. Traditional technologies, such as Pop 3 and Exchange, may be used, as well as other formats. The custom software 147 may be configured to cause the processing system 141 to perform one or more of the operations described herein in conjunction with the operating system 143 and, when appropriate, the email server 145.

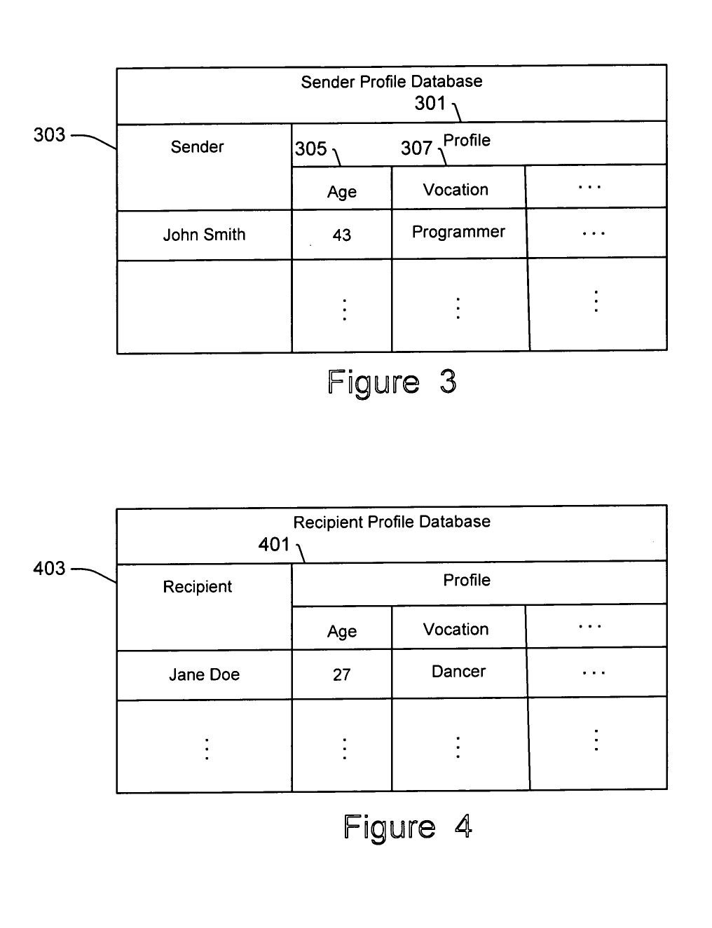

FIG. 3 illustrates one embodiment of the sender profile database 131 illustrated in FIG. 1. The sender profile database 131 may be configured to store a profile 301 of each of a plurality of potential email senders 303 that may use email server 145 to send their outgoing emails. These may include email senders that have subscribed to the promotional message augmentation system 113, such as the email subscriber/recipient systems 101 and 103.

As shown in FIG. 3, the profile may include various fields of information about the senders, such as age 305 and vocation 307. The profile may include different or additional fields of profile information, such as one or more of the fields discussed above in connection with the email address book record illustrated in FIG. 2. The information that is contained within the sender profile database 131 may be obtained from senders that subscribe to the services that are provided by the promotional message augmentation system 113, such as the email senders/recipients systems 101 and 103. This may be done at the time they subscribe to the service or at any other time. At the time of subscribing, all or portions of the custom software 121 may be downloaded and, in certain cases, installed.

Various inducements may be provided to prospective subscribers to encourage them to subscribe to the promotional message augmentation system 113. These inducements may include the free or reduced-charge usage of the email server 145 for incoming and/or outgoing emails, spam blocking, cash, discounts, reward points redeemable for cash, products, services, and/or the right to participate in a lottery.

FIG. 4 illustrates one embodiment of the recipient profile database 133 illustrated in FIG. 1. The recipient profile database 133 may be configured to store a profile 401 of each of a plurality of potential email recipients 403 to whom email may be sent by subscribers using the email server 145. The recipient profile database 133 may contain any of the types of profile fields that were discussed above in connection with the sender profile database 131. As will be explained in more detail below, the information in the recipient profile database 133 may be obtained from subscribers to the promotional message augmentation system 113 or developed or augmented from email promotional links that are clicked by recipients of emails containing promotional messages.

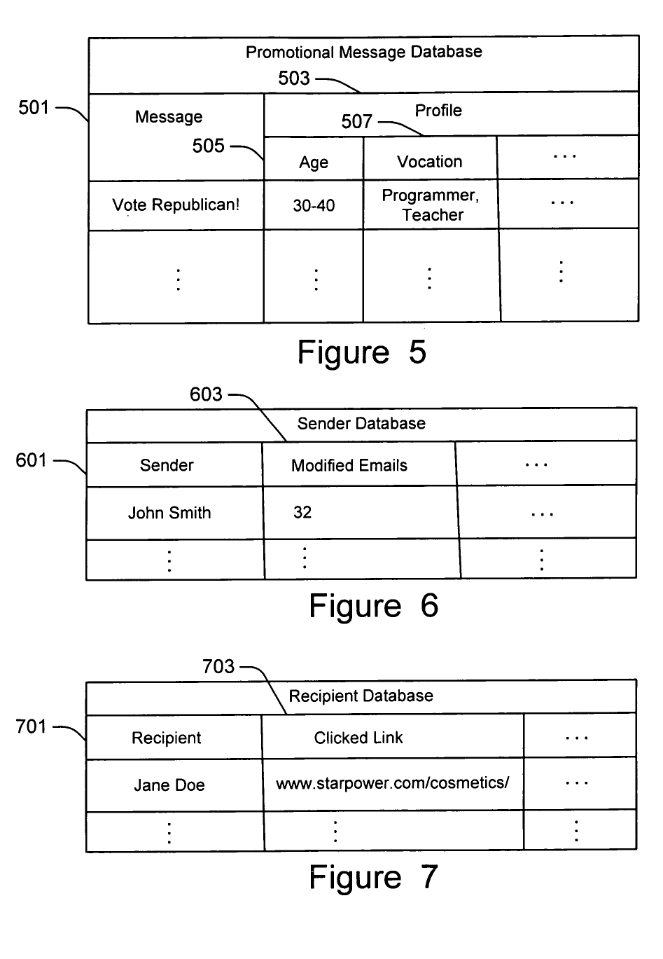

FIG. 5 illustrates one embodiment of the promotional message database 135 illustrated in FIG. 1. As shown in FIG. 5, the promotional message database 135 may include a series of promotional messages 501, each with a profile 503 of preferred recipients of the promotional message. Again, any type of profile information may be used, such as one or more of the profile fields that were discussed above in connection with the email address book record illustrated in FIG. 2. Unlike the profiles contained in the sender profile database 131 and the recipient profile database 133, however, ranges of values or multiple values may be stored in connection with each type of profile. As shown in FIG. 5, for example, the range of 30-40 may be stored in connection with the age field 505, while the values programmer and teacher may be stored in connection with the vocation field 507.

The promotional messages that are contained within the promotional message database 135, as well as the profiles that are associated with each, may be supplied by one or more advertisers. Each promotional message may consist of text, HTML code, graphics, links, video or any other format of information, as well as any combination of these. The message may be configured to be imbedded in and/or or attached to an email. Each message may contain content intended to promote a product or service or anything else, such as a political candidate. Each message may in addition or instead contain any other type of content.

The promotional message database 135 may include additional fields of information, such as information identifying the advertisers that provided each promotional message, the number of times each promotional message has been embedded in an email in accordance with a process that will be explained below, and/or the number of times a link in an embedded promotional message has been clicked by recipients of that message, also in accordance with a process that will be explained below. Advertisers that have provided promotional messages may be given selected access to the promotional message database 135 to obtain statistical information that has been stored about the use of each promotional message that they have placed, as well as other types of related reports.

FIG. 6 illustrates one embodiment of the sender database 137 illustrated in FIG. 1. The sender database 137 may track the number of emails from each subscriber that the promotional message augmentation system 113 has modified in accordance with a process that will be described below. As shown in FIG. 6, the sender database 137 may include a sender field 601 identifying the sender and a count field 603 identifying the number of emails from that sender that have been modified by the promotional message augmentation system 113. Other fields may be used, such the an email address, street address, and/or telephone number of the sender.

FIG. 7 illustrates one embodiment of the recipient database 139 illustrated in FIG. 1. The recipient database 139 may contain information about the promotional links in email messages that recipients of those messages click. As shown in FIG. 7, the recipient database 139 may include fields such as a recipient field 701 identifying the recipient and a clicked link 703 field identifying a link that the recipient has clicked. Other fields may be provided, such as a field identifying the email address, street address, and/or telephone number of the recipient, as well as a field identifying the number of times each recipient has clicked each link.

The sender database 137 may be combined with the sender profile database 131 or may be maintained separately. Similarly, the recipient database 139 may be combined with the recipient profile database 133 or may be maintained separately.

A test website 149 may be included. As will be explained in more detail below, the test website 149 may be used to administer a test to email senders that are not listed in either the approved sender database 125 or the blocked sender database 127.

Examples of processes that may be performed by the illustrative components discussed above and/or by other components will now be described.

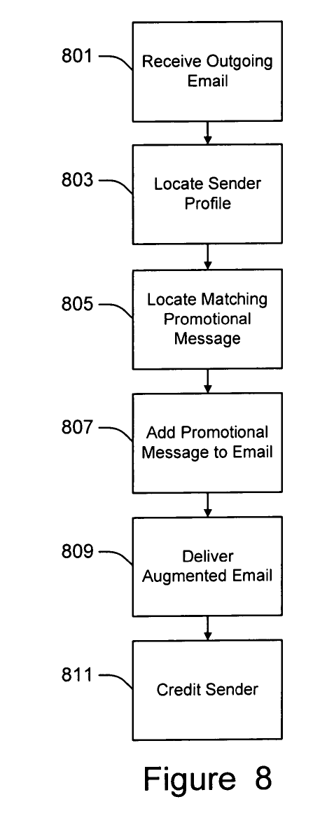

FIG. 8 illustrates one embodiment of a targeted email process. An outgoing email from a subscriber to the promotional message augmentation system 113, such as from the email sender/recipient system 101, may be received by the promotional message augmentation system 113, as reflected by a Receive Outgoing Email block 801. To facilitate this, the email client 119 in the email sender/recipient system 101 may be configured to deliver outgoing emails to the email server component 145 in the promotional message augmentation system 113.

Upon receipt, the processing system 141 in the promotional message augmentation system 113 may examine the email for the purpose of identifying its sender. The processing system 141 may then access the sender profile database 131 for the purpose of locating the profile of the sender, as reflected by a Locate Sender Profile block 803.

The processing system 141 may then access the promotional message database 135 for the purpose of locating one or more promotional messages that bear a profile or a profile range that is appropriate for the located sender profile, such as a profile that matches the located sender's profile or a profile that is similar to the located sender's profile. This is reflected in a Locate Matching Promotional Message block 805. Matching scores may be computed and the promotional message or messages with the best score(s) may be selected. Other matching criteria may be employed.

The appropriate promotional message or messages that are located may then be added to the sender's email, as reflected by an Add Promotional Message to Email block 807. If more than one appropriate promotional message is located, only one, some or all of these located promotional messages may be added to the sender's email. If certain appropriate messages are located, but not included in the sender's email, a round-robin system may be implemented to ensure that all promotional messages that are appropriate for a particular profile are ultimately included within one or more outgoing emails. Data relating to the round-robin system may be stored in the promotional message database 135 or elsewhere.

Each promotional message may be inserted in the sender's email at any location, such as at the bottom of the email, in the middle of the email or at the beginning of the email. It may also or instead be associated with the email as an attachment.

The augmented email may then delivered back into the Internet 111 for delivery to the recipient that is identified in the email, as reflected by a Deliver Augmented Email block 809. The sender database 137 may then be updated to increment the count of the number of emails of the sender that the promotional message augmentation system 113 has augmented, as reflected by a Credit Sender block 811. The fact that a particular promotional message was added to an outgoing email and/or the number of times it was added may be stored in the promotional message database 135 or elsewhere and later made available to the advertiser that requested the promotional message.

The success of the process illustrated in FIG. 8 may be based on the assumption that a sender often communicates with recipients having profiles similar to the sender's. In this way, profile targets set by advertisers may often be achieved or substantially achieved by the process illustrated in FIG. 8, even when no profile information about a recipient is known.

In some cases, a single email may designate several recipients. In this instance, steps 807, 809 and 811 in the process illustrated in FIG. 8 may be performed for each recipient. If a round-robin system is being implement, step 805 may be repeated for the purpose of locating, attaching and delivering the different matching promotional messages in the round-robin.

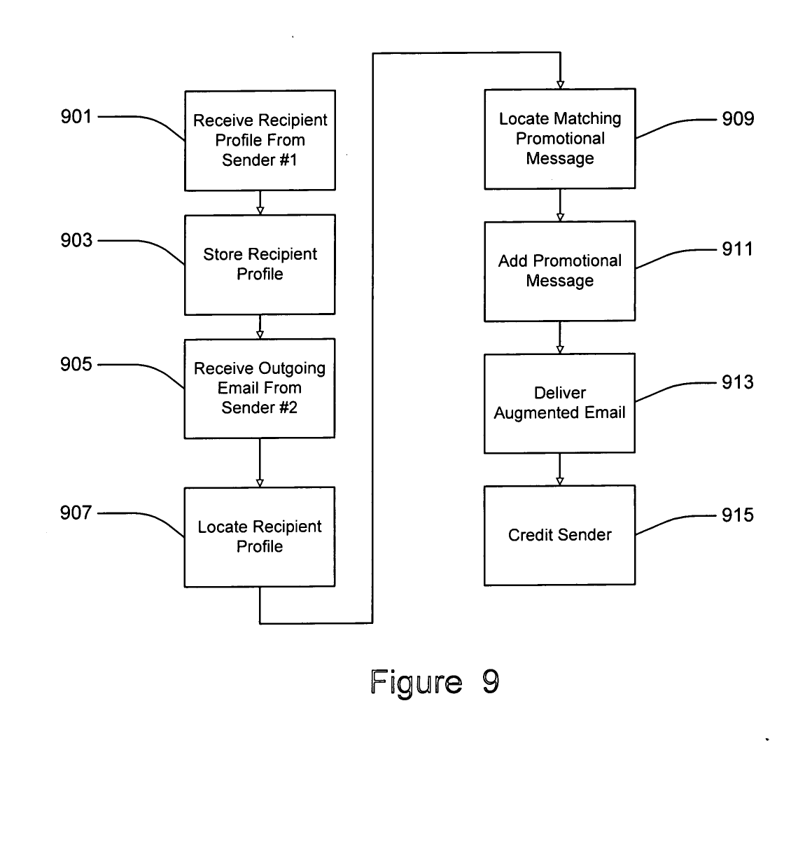

FIG. 9 illustrates another embodiment of a targeted email process. As explained above, each subscriber, such as the email sender/recipient system 101, may maintain an email address database, such as the email address database 123, that contains profile information about persons to whom the email sender/recipient system may send emails. Information from each subscriber's email address database may be delivered to the promotional message augmentation system 113 and stored in its recipient profile database 133. This delivery may occur at the time the subscriber signs up for the service. It may also or instead occur at later times and may be initiated either manually or automatically by the email sender/recipient system 101, by the promotional message augmentation system 113, and/or by any other means.

The receipt of one such recipient profile from one such sender, such as from the email sender/recipient system 101, is referenced in FIG. 9 as a Receive Recipient Profile From Sender #1 block. The recipient profile information that has been received may be stored in the recipient profile database 133, as reflected by a Store Recipient Profile block 903.

At some later time, the promotional message augmentation system 113 may receive an outgoing email from a different subscriber, such as the email sender/recipient 103, as reflected in a Receive Outgoing Email From Sender No. 2 block 905.

The designated recipient in the email may then be determined by the processing system 141. The profile of this designated recipient may then be located in the recipient profile database 133, as reflected in a Locate Recipient Profile block 907. The step is much the same as the Locate Sender Profile block 803 in FIG. 8, except that the look-up is performed in the recipient profile database 133 for the purpose of locating the profile of the recipient, rather than in the sender profile database 131 for the purpose of locating the profile of the sender.

In many cases, the matching profile that is returned from the recipient profile database 133 will not be a profile that was supplied by the sender of the email message (e.g., Sender No. 2 in this example), but rather one that was provided by a different subscriber (e.g., Sender No. 1 in this example). By merging the recipient profiles that are received from several different subscribers in a single recipient profile database 133, cross-fertilization of this type can occur.

The remaining steps in the process illustrated in FIG. 9, namely a Locate Matching Promotional Message block 909, an Add Promotional Message block 911, a Deliver Augmented Email block 913 and a Credit Sender block 915, may be implemented by the same or similar steps as were discussed above in connection with the same-named steps in FIG. 8.

One difference between the process shown in FIG. 8 and the process shown in FIG. 9 is that messages are matched to the profile of the sender in FIG. 8, while they are matched to the profile of the recipient in FIG. 9. The process described in FIG. 9 has the capacity to share recipient profile information among multiple subscribers.

When a single email message designate several recipients, the steps 907, 909, 911, 913 and 915 may be performed separately for each designated recipient.

The processing system 141 in the promotional message augmentation system 113, including the custom software 147, may be configured to implement either or both of the processes set forth in FIGS. 8 and 9. If it is configured to implement only the process set forth in FIG. 8, the recipient profile database 133 may not be needed. Conversely, if it is configured to implement only the process set forth in FIG. 9, the sender profile database 131 may not be needed.

When the processing system 141 is configured to implement both the processes of FIG. 8 and FIG. 9, an algorithm may be included in the processing system 141 that determines whether to use the sender profile, the recipient profile, and/or a combination of both profiles for the purpose of locating the appropriate promotional message(s) that are to be added to the email. In one embodiment, the profile of the recipient may be used first if it is available from the recipient profile database 133. If it is not, the sender profile from the sender profile database 131 may be used instead. A combination of the sender and recipient profiles may be used if both are available.

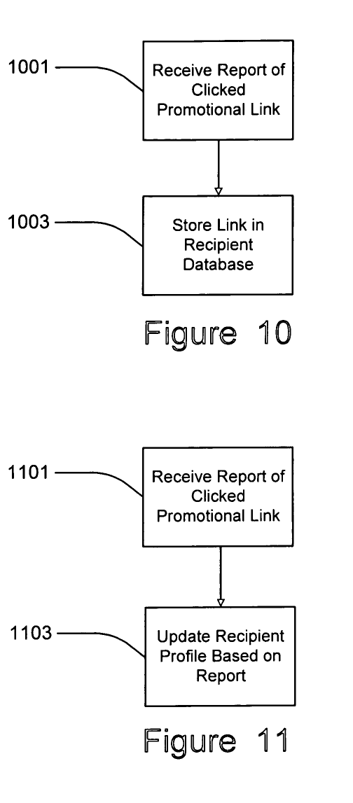

FIG. 10 illustrates one embodiment of a promotional accounting process. This process may be used in connection with the promotional message augmentation system 113 shown in FIG. 1.

As indicated above, one or more of the promotional messages that are added to outgoing email messages may include links, such as links to promotional websites. The recipients of these messages, in turn, may click these links and visit their targets, such as the promotional websites. A report that a particular link was clicked may be received by the promotional message augmentation system 113, as reflected by a Receive Report of Clicked Promotional Link block 1001. This report may include information identifying the recipient, the sender that sent the message containing the link, and/or the actual link that was clicked or a code for it. Information in the report may then be stored. For example, the link that the recipient clicked may be stored in the recipient database 139, as illustrated by the example shown in FIG. 7. This is reflected by a Store Link and Recipient Database block 1003. Alternately, a code for the link may be stored.

In this way, the links that a particular recipient clicks can be tracked by the promotional message augmentation system 113. This provides a means for giving credit to the sender of the email message for the clicked link. This facilitates making an accounting for clicked links in connection with the advertiser that provided the promotional message that contained the clicked link.

As should be apparent to those skilled in the art, there are a broad variety of techniques that may be used to facilitate the delivery of such reports to the promotional message augmentation system 113. One such approach is to include a unique code with each embedded link that identifies the sender and/or the recipient of the message. The target to where the link points, such as a website, may be configured to read this unique code and to deliver it to the promotional message augmentation system 113. The target may process the codes, such as to tally the number of clicked links that originated from the promotional message and augmentation system 101. It may also or instead decode the code. It may send the tally and/or decoded information to the promotional message and augmentation system 101, with or without the unique code.

FIG. 11 illustrates one embodiment of an automated recipient profile development process. This process may be used in connection with the promotional message augmentation system 113.

Like step 1001 in FIG. 10, a report of each promotional link clicked by a recipient may be received by the promotional message augmentation system 113, as reflected in a Receive Report of Clicked Promotional Link block 1101. This report may identify the recipient. It may identify the link that the recipient clicked. It may also or instead include information from which this information can be determined. The information in the report may then be used by the processing system 141 to develop a a profile about the recipient and to store that developed profile in the recipient profile database 133, as reflected by an Update Recipient Profile Based On Report block 1103. If a profile of the recipient was already contained within the recipient profile database 133, the information from the report may instead be used to fine tune that profile, as also reflected by the Update Recipient Profile Based On Report block 1103. The information needed to generate or update the recipient's profile may be based on the profile information that was stored in the promotional message database 135 in association with the promotional message in which the clicked link was embedded. Additional fields of information may be included in the promotional message database 135 to facilitate or augment this function.

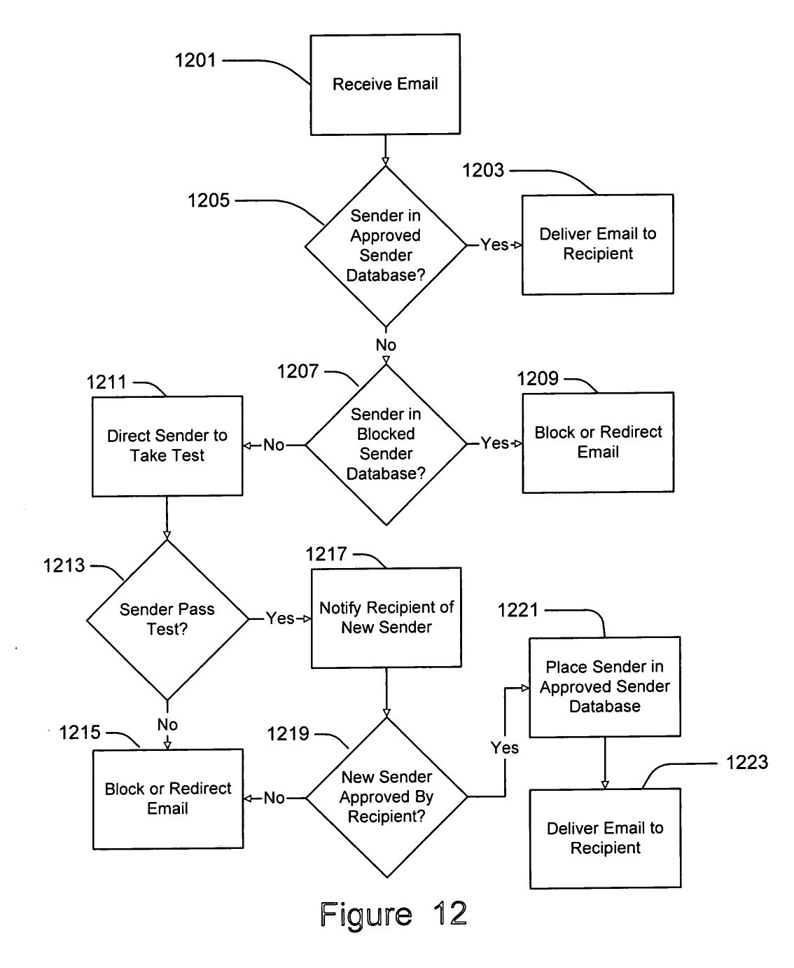

As indicated above, one way of inducing email senders to subscribe to the promotional message augmentation system 113 is to offer them a spam blocking system and/or service for free or for a reduced price. FIG. 12 illustrates one embodiment of a two-tier email filtering process that may be included in such an offer.

An email destined for a subscriber, such as the email sender/recipient system 101, may be received by the email server 145, as reflected by a Receive Email block 1201. A check may made to determine whether the sender of the email is listed in the approved sender database 125, as reflected by a Sender in Approved Sender Database? decision block 1205. This check may be made by the processing system 141 accessing the approved sender database 125 through the processing system 115. Alternatively, the email may be downloaded from the email server 145 by the processing system 115 and the processing system 115 may determine whether the sender is in the approved sender database 125.

If the sender is listed in the approved sender database 125, the email may be delivered to the recipient, as reflected in a Deliver Email To Recipient block 1203. This may be accomplished by the processing system 141 or, in the alternative embodiment, by the processing system 115.

On the other hand, if the sender is not listed in the approved sender database 125, a check may be made to determine whether the sender is listed in the blocked sender database 127, as reflected by a Sender In Blocked Sender Database? decision block 1207. Again, this may be performed by either the processing system 141 or the processing system 115. The check of the blocked sender database may instead be performed before the check of the approved sender database.

If the sender is listed in the blocked sender database 127, the email may be blocked from reaching the recipient, such as by deleting the email, as reflected by a Block or Redirect Email block 1209. The email may instead be redirected, such as by placing it in a special folder or other area segregated from the recipient's normal emails.

If the sender is not listed in either the approved sender database or the blocked sender database, a message may be sent to the sender directing the sender to take a test, as reflected by a Direct Sender To Take Test block 1211. Such as message could be sent to the sender at the email address provided by the sender in his email. It could instead be sent to the sender by other means. The message may be sent by the processing system 141 or, in the alternative embodiment, the processing system 117.

The test may be configured to test whether the email was sent by an automated system or by an individual. An example of such a configuration is to direct the sender to a website, such as the test website 149 shown in FIG. 1. The processing system 115 or 139 may accomplish this by automatically replying to the email with a message to the sender that includes a link to the test website 149 and an advisory that his message has been placed on hold until the sender clicks the link and follows the instructions at the target website. The embedded link may be customized to include a code that uniquely identifies the sender.

During the sender's visit to the test website 149, the test website 149 may present a test to the sender.

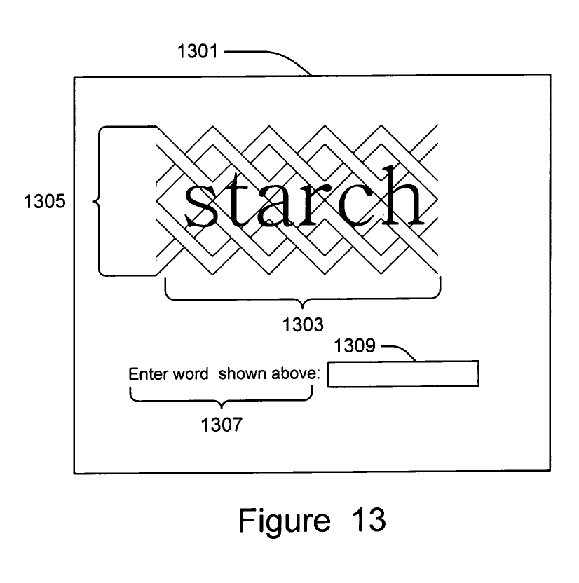

FIG. 13 illustrates one embodiment of the web page test that may be presented by the test website 149. As illustrated in FIG. 13, a web page 1301 may include a randomly selected word or set of characters 1303 placed against a partially-obscuring background 1305. Although a word known to the English language is shown in the example, arrangements of characters that have no meaning may be used instead. Similarly, although a cross-hatch pattern has been shown, different patterns or even backgrounds with no patterns may be used instead. The color of the characters 1303 and the background 1305 may be the same, similar, or different. The characters 1303 and the background 1305 may be selected so as to ensure that the characters 1303 can be read by an individual, but not readily by a machine implementing a pattern-recognition algorithm that does not consume significant time to process.

The web page 1301 may include a message 1307 that directs the sender to enter the characters that he sees on the screen in an entry area 1309. If the sender complies with this instruction and the entry matches the characters 1303, the sender may be deemed to have passed the test. On the other hand, if the sender does not enter the characters or if the entry does not match, the sender may be deemed to have failed the test. The passage or failure of the test is reflected by a Sender Passed Test? decision block 1213.

The test website 149 may communicate the results of the test or information about the entry made by the sender to the processing system 141, the processing system 115 and/or elsewhere. If the test website merely communicates information about the entry that the sender made, the determination as to whether the sender passes the test may be made by the processing system 141, the processing system 115 or elsewhere. The communication from the test website 149 may include information identifying the sender. This information may be the code that may have been included with the link clicked by the sender to get to the test website 149, it may have been entered by the sender while visiting the test website 149, or may come from any other source.

If the sender fails the test, the email may be blocked or redirected as reflected by a Block Or Redirect Email block 1215. If it is blocked, the email may be deleted. If it is redirected, it may be placed in a segregated area for the recipient. A message may also or instead be sent to the sender alerting the sender to the test failure. The recipient may be given the opportunity to add the sender to the approved sender database 125 and/or to the blocked sender database 127. The system may instead be configured to automatically list a sender that fails the test in the blocked sender database 127.

If the sender passes the test, on the other hand, the recipient may be notified of the passage, as reflected by a Notify Recipient of New Sender block 1217. The system may instead or in addition place the email from the sender in the in-box of the recipient or in a segregated area.

Before delivering the email to any box, the system may instead ask the recipient to approve the new sender, as reflected by a New Sender Approved By Recipient? decision block 1219. If the recipient declines, the email message may be blocked or redirected, as reflected by the Block Or Redirect Email block 1215. If blocked, it may be deleted. If redirected, it may be placed in a segregated area. The recipient may be asked whether to place the disapproved sender in the blocked sender database 127. The system may alternatively be configured to automatically perform this operation once the recipient disapproves the sender.

If the recipient approves the sender, on the other hand, the sender may be placed in the approved sender database 125, as reflected by a Place Sender In Approved Sender Database block 1221. The email may be delivered to the in-box of the recipient, as reflected by a Deliver Email To Recipient block 1223.

As should now be apparent, the process illustrated in FIG. 12 may vary in sequence and in the steps that are taken in many ways. This includes wide variation in the required involvement of the recipient in the process and in the management of emails from senders that are listed in the blocked sender database 127, that failed the test, or that were disapproved by the recipient.

The process in FIG. 12 may advantageously be used in connection with the targeted email promotion system with two-tier filtering illustrated in FIG. 1. Alternatively, this process may be used as a stand alone process, separate from the system illustrated in FIG. 1.

The involvement of advertisers may vary widely. For example, the promotional message augmentation system 113 may be configured to bill advertisers based on the number of times a promotional message is appended to an email, the number of times that a link within an appended promotional message is clicked by a recipient, and/or actual purchases or other actions of the recipients. This tracking information may be stored in the promotional message database 135 and/or in a different database.

An embodiment of a targeted email promotion system with or without two-tier filtering may be licensed to organizations, such as businesses, that wish to append their own promotional messages to emails that are sent by their members or employees. The two-tier filtering system may separately be licensed to organizations and/or individuals.

Compensation may be provided for the referral of subscribers. The compensation may be based on the number of subscribers that are referred, the number of emails that the subscribers send, the number of embedded promotional links that are clicked, the purchases that targeted recipients make, or by a combination of these approaches.

Although having focused on e-mail messages, messages of other types may also be managed in the same or similar ways, such as wireless text messaging.

In short, only examples of systems, components, processes and steps have been provided. Protection is to be limited solely to the claims that now follow.

1. An email-based promotional message delivery system comprising:
a sender profile database configured to store a profile of each of a plurality of potential email senders;
a promotional message database configured to store a plurality of promotional messages and, for each, a profile of preferred recipients of the message; and
a processing system configured to receive a plurality of outgoing emails from a plurality of different senders, each email containing information identifying the sender and at least one recipient, and configured in connection with each received email to:
locate the profile of the sender of the email in the sender profile database;
locate at least one promotional message in the promotional message database that has a profile that is appropriate for the profile of the sender;
add the at least one located promotional message to the email; and direct the augmented email to the at least one recipient of the email.

2. An email-based promotional message delivery process for use in connection with a sender profile database configured to store a profile of each of a plurality of potential email senders and a promotional message database configured to store a plurality of promotional messages and, for each, a profile of preferred recipients of the message, the process comprising:
receive a plurality of outgoing emails from a plurality of different senders, each email containing information identifying the sender and at least one recipient, and in connection with each received email:
locate the profile of the sender of the email in the sender profile database;
locate at least one promotional message in the promotional message database that has a profile that is appropriate for the profile of the sender;
add the at least one located promotional message to the email; and direct the augmented email to the at least one recipient of the email.

3. An email address database configured to be accessed electronically by an email application and configured to store and deliver information identifying a plurality of potential email recipients and, in connection with each, information about his or her income.

4. An email address database configured to be accessed electronically by an email application and configured to store and deliver information identifying a plurality of potential email recipients and, in connection with each, information about his or her vocation.

5. An email address database configured to be accessed electronically by an email application and configured to store and deliver information identifying a plurality of potential email recipients and, in connection with each, information about his or her race.

6. An email address database configured to be accessed electronically by an email application and configured to store and deliver information identifying a plurality of potential email recipients and, in connection with each, information about the number of his or her children.

7. An email address database configured to be accessed electronically by an email application and configured to store and deliver information identifying a plurality of potential email recipients and, in connection with each, information about his or her hobbies.

8. An email-based promotional message delivery system comprising:
a recipient profile database configured to store a profile of each of a plurality of potential email recipients;
a promotional message database configured to store a plurality of promotional messages and, for each, a profile of preferred recipients of the message; and
a processing system configured to:
receive recipient profiles from email address databases maintained by a plurality of email senders;
store the recipient profiles in the recipient profile database;
receive an outgoing email from an email sender, the email containing information identifying at least one intended recipient of the email;
locate the profile of the intended recipient in the recipient profile database;
locate at least one promotional message in the promotional message database that has a profile that is appropriate for the located profile of the at least one intended recipient;
add the at least one located promotional message to the email; and
direct the augmented email to the at least one intended recipient.

9. An email-based promotional message delivery process for use in connection with a recipient profile database configured to store a profile of each of a plurality of potential email recipients; a promotional message database configured to store a plurality of promotional messages and, for each, a profile of preferred recipients of the message; and email address databases maintained by a plurality of email senders, each configured to store a profile of each of a plurality of prospective email recipients, the process comprising:
receive recipient profiles from the email address databases;
store the recipient profiles in the recipient profile database;
receive an outgoing email from an email sender, the email containing information identifying at least one intended recipient of the email;
locate the profile of the intended recipient in the recipient profile database;
locate at least one promotional message in the promotional message database that has a profile that is appropriate for the located profile of the at least one intended recipient;
add the at least one located promotional message to the email; and
direct the augmented email to the at least one intended recipient.

10. An email-based system comprising:
a recipient database configured to store information identifying recipients that have clicked links embedded in their email messages and information identifying the links that the recipients have clicked; and
a processing system configured to:
receive reports about recipients that have clicked links embedded in their email messages; and
update the recipient database to reflect information in the reports.

11. An email-based process for use in connection with a recipient database configured to store information identifying recipients that have clicked links embedded in their email messages and information identifying the links that the recipients have clicked, the process comprising:
receive reports about recipients that have clicked links embedded in their email messages; and
update the recipient database to reflect information in the reports.

12. An email-based system comprising:
a recipient database configured to store information identifying recipients that have clicked links embedded in their email messages and a profile of each recipient; and
a processing system configured to:
receive reports about recipients that have clicked links embedded in their email messages; and
update the recipient profiles in the recipient database based on the reports.

13. An email-based process for use in connection with a recipient database configured to store information identifying recipients that have clicked links embedded in their email messages and a profile of each recipient; the process comprising:
receive reports about recipients that have clicked links embedded in their email messages; and
update recipient profiles in the recipient database based on the reports.

14. An email-based modification system comprising:
a sender database configured to store information about a plurality of email senders, including information about the number of emails from each sender that the modification system has modified; and
a processing system configured to receive a plurality of emails from the plurality of senders, each email containing information identifying the sender and at least one recipient, and configured in connection with each received email to:
modify the email;
direct the modified email to the at least one recipient; and
update the information in the sender database about the number of emails from the sender to reflect that another email has been modified.

15. An email-based modification process for use in connection with a sender database configured to store information about a plurality of email senders, including information about the number of emails from each sender that the modification system has modified, the process comprising:
receive a plurality of emails from a plurality of senders, each email containing information identifying the sender and at least one recipient, and for each received email:
modify the email;
direct the modified email to the at least one recipient; and
update the information in the sender database about the number of emails from the sender to reflect that another email has been modified.

16. A message-based promotional process comprising:
receive a plurality of messages from a plurality of senders, each message containing information identifying the sender and at least one recipient, and for each received message:
modify the message by adding a promotional component to the message; and
direct the modified message to the at least one recipient; and
compensate the senders for allowing promotional components to be added to their messages.

17. The message based promotional process of claim 16 wherein each sender is compensated based on the number of his messages that the process modifies.

18. The message-based promotional process of claim 16 wherein each message is an e-mail.

19. The message based promotional process of claim 18 wherein each promotional component includes at least one embedded link and wherein each sender is compensated based on the number of embedded links that are clicked by the recipients of his messages.

20. The message based promotional process of claim 18 wherein:
each promotional component includes at least one embedded link;
some of the recipients click a link embedded in a modified message that they receive and make one or more purchases at the websites to which the links points; and
senders are compensated based on these purchases.

21. The message-based promotional process of claim 16 wherein each message is a wireless text messaging message.
